(19) United States
(12) Patent Application Publication
(10) Pub. No.: US 2017/0067446 A1
(43) Pub. Date: Mar. 9, 2017

(54) APPARATUS AND METHOD FOR POWER GENERATION USING COMPRESSED AIR

(71) Applicant: Utah Valley University Foundation, Inc, Orem, UT (US)

(72) Inventor: Kevin Shurtleff, Orem, UT (US)

(21) Appl. No.: 15/257,862

(22) Filed: Sep. 6, 2016

Related U.S. Application Data
(60) Provisional application No. 62/213,754, filed on Sep. 3, 2015.

(51) Int. Cl. F03D 9/28; F03D 9/17; B64B 1/40; H02K 7/18

(52) U.S. Cl. CPC F03D 9/28; H02K 7/1807; F03D 9/17; B64B 1/40; F05B 2240/922; F05B 2240/21

(57) ABSTRACT

Apparatuses, methods, and systems are disclosed for power generation using compressed air. One apparatus includes a wind turbine and an air compressor coupled to the wind turbine. The air compressor compresses air in response to rotation of blades of the wind turbine. The apparatus also includes a balloon that lifts the wind turbine and the air compressor off the ground. The apparatus includes a tube that directs the air compressed by the air compressor from the balloon to a receiving unit on the ground.

### CROSS-REFERENCES TO RELATED APPLICATIONS

This application claims the benefit of U.S. Provisional Patent Application No. 62/213,754 entitled “Clean, low cost, sustainable, renewable energy electrical generation for underdeveloped communities using compressed air” and filed on Sep. 3, 2015 for Kevin Shurtleff, which is incorporated herein by reference.

### FIELD OF THE INVENTION

This invention relates to power generation and more particularly relates to power generation using compressed air.

### BACKGROUND

Wind may be used to produce power. In certain configurations, a wind turbine includes blades that rotate in response to wind. The rotation of the blades may be used to rotate an electrical generator to produce power. Such wind turbines may be mounted to a pole or tower 60 to 100 feet tall.

### SUMMARY

An apparatus for power generation using compressed air is disclosed. A method and system also perform the functions of the apparatus. In one embodiment, the apparatus includes a wind turbine and an air compressor coupled to the wind turbine. The air compressor compresses air in response to rotation of blades of the wind turbine. The apparatus also includes a balloon that lifts the wind turbine and the air compressor off the ground. The apparatus includes a tube that directs the air compressed by the air compressor from the balloon to a receiving unit on the ground.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system for power generation using compressed air;

FIG. 2 is a schematic block diagram illustrating one embodiment of a compressed air generation system;

FIG. 3 a schematic block diagram illustrating one embodiment of a lift system;

FIG. 4 a schematic block diagram illustrating one embodiment of a ground system;

FIG. 5 a schematic block diagram illustrating one embodiment of a solar power production system;

FIG. 6 a schematic block diagram illustrating one embodiment of a solar air compression system;

FIG. 7 a schematic block diagram illustrating one embodiment of a wave powered air compressor;

FIG. 8 a schematic block diagram illustrating one embodiment of a water powered air compressor; and

FIG. 9 is a schematic flow chart diagram illustrating an embodiment of a method for power generation using compressed air.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. One skilled in the relevant art will recognize that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

In some configurations, a wind turbine is mounted on a pole or tower approximately 60 to 100 feet above the ground. The wind turbine may be used to directly rotate an electrical generator. However, the average wind velocity at 1,000 feet above the ground may be approximately twice the wind velocity at 100 feet. Accordingly, a wind turbine at 1,000 feet may produce more power than a wind turbine at 100 feet.

Wind power production may be a function of wind velocity according to the following equation: P=½ ρAV³. In this equation, P=power in watts; ρ=air density (at 1.2 kg/m³ at sea level and 20° C.); A=the swept area of turbine blades (in m² or square meters); and V=wind speed (in meters per second). According to this equation, if the wind velocity doubles (e.g., wind velocity at 1,000 feet may be approximately double wind velocity at 100 feet) a wind generation system will produce eight times the power as an equivalent system without the wind velocity doubling.

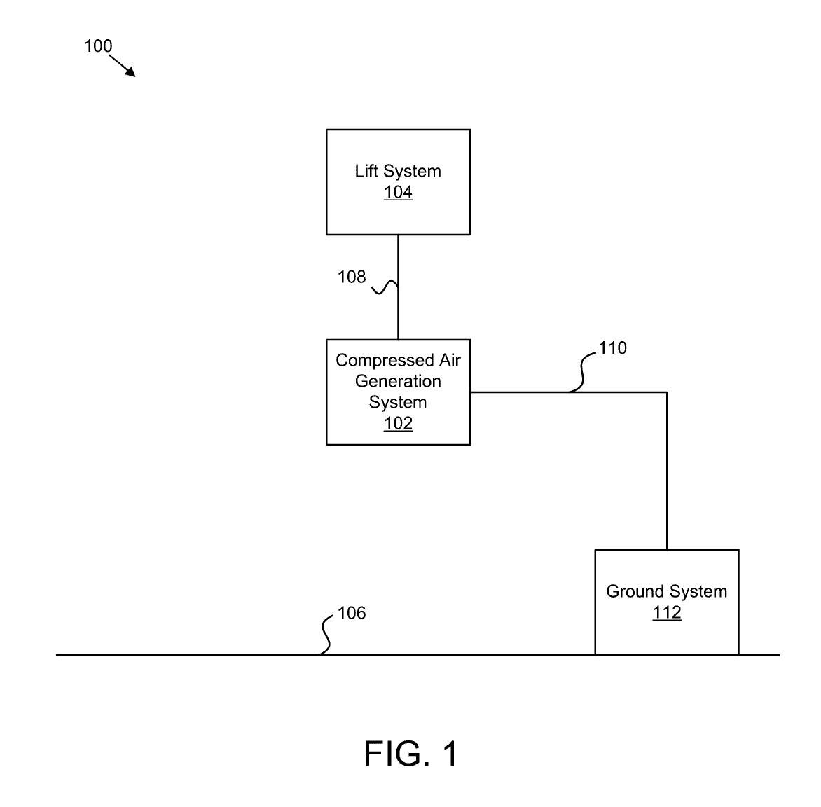

A typical wind turbine/generator system may produce 12-24 volts. Therefore, a 2 kW generator may produce 166-83 amps of electrical current, respectively. A properly sized copper cable capable of carrying this amount of current may be approximately ½″ in diameter. As may be appreciated, 1,000 feet of ½″ diameter cable may be excessively heavy to lift to 1,000 feet and may be excessively expensive. FIG. 1 illustrates one embodiment of how to get the energy generated at 1,000 feet down to the ground.

FIG. 1 is a schematic block diagram illustrating one embodiment of a system 100 for power generation using compressed air. The system 100 includes a compressed air generation system 102 that generates compressed air using wind power. The system 100 also includes a lift system 104 that lifts the compressed air generation system 102 off of a ground 106 into the air. In certain embodiments, the lift system 104 may lift the compressed air generation system 102 up to a height that is 100 to 1000 feet above the ground 106. In some embodiments, the lift system 104 may lift the compressed air generation system 102 to a height that is less than 100 feet above the ground 106, or to a height that is greater than 1000 feet above the ground 106.

The lift system 104 is coupled to the compressed air generation system 102 by a securing device 108 to lift the compressed air generation system 102 above the ground 106. The securing device 108 may include one or more of a rope, a wire, a line, a basket, a container, a securing mechanism, and so forth.

Tubing 110 is coupled to the compressed air generation system 102 and directs compressed air from the compressed air generation system 102 to a ground system 112 for use and/or storage.

In one embodiment, the compressed air generation system 102 includes a lightweight, aluminum, air compressor. Moreover, in certain embodiments, the lift system 104 includes multiple weather balloons (e.g., 2, 3, 4, 5, and so forth) to lift the compressed air generation system 102. The weather balloons may be any suitable diameter (e.g., 10 feet, 12 feet, 14 feet, 16 feet, and so forth) and may be constructed to be durable and withstand outdoor environments for a substantial period of time (e.g., 1 year, 2 years, 5 years, 30 years, and so forth). For example, weather balloons may be constructed by to withstand outdoor environments by spraying a standard weather balloon with an additional layer of latex to make it stronger.

In various embodiments, compressed air is transferred to the ground 106 through 1,000 feet of the tubing 110. In some embodiments, the tubing 110 may be a lightweight plastic tubing rolled on a spool. In certain embodiments, the spool may be automated so that it may pull in the lift system 104 and compressed air generation system 102 as desired (e.g., such as during excessive wind conditions).

In some embodiments, the compressed air generated by the compressed air generation system 102 may be stored in a collection of tanks until it is used to drive an air motor that turns an electrical generator. Accordingly, the compressed air may be one form of energy storage used to store energy until needed. As such, compressed air storage may make wind power more stable. This may be especially important for small distributed power systems that supply electricity to an isolated home or small village because there may be no electrical grid available for backup power during low or no wind conditions.

In some embodiments, a pole mounted system may cost $3,500 for a 2 kW wind turbine; and the system 100 including the compressed air generation system 102, the lift system 104, the securing device 108, and the tubing 110 may cost $4,500 for a 2 kW wind turbine. In such embodiments, including conversion losses that may be present in the system 100, the cost of electricity from the system 100 may be approximately $19 per MWhr, which may be ¼ the cost of electricity from the pole mounted system in which the cost of electricity may be $76 per MWhr. In addition, electricity from the system 100 may be significantly less than the lowest cost electricity available in the United States from coal. For example, in Utah where 80% of the electricity is generated from coal, the average electricity cost may be approximately $67 per MWhr.

Although compressed air storage may provide some load leveling to compensate for variations in the wind, integrating additional sources of clean, renewable energy into the system may increase the amount of power generated and improve the stability of the power generation. For example, solar energy peaks in the middle of the day, often matching the peak in power demand, making it an excellent source of energy production. As may be appreciated, there is no solar energy available at night, when demand is typically at its lowest. Because the wind tends to peak during storms and storms reduce the amount of available solar energy, it may be useful to combine wind energy production with solar energy production for improved system performance and load leveling.

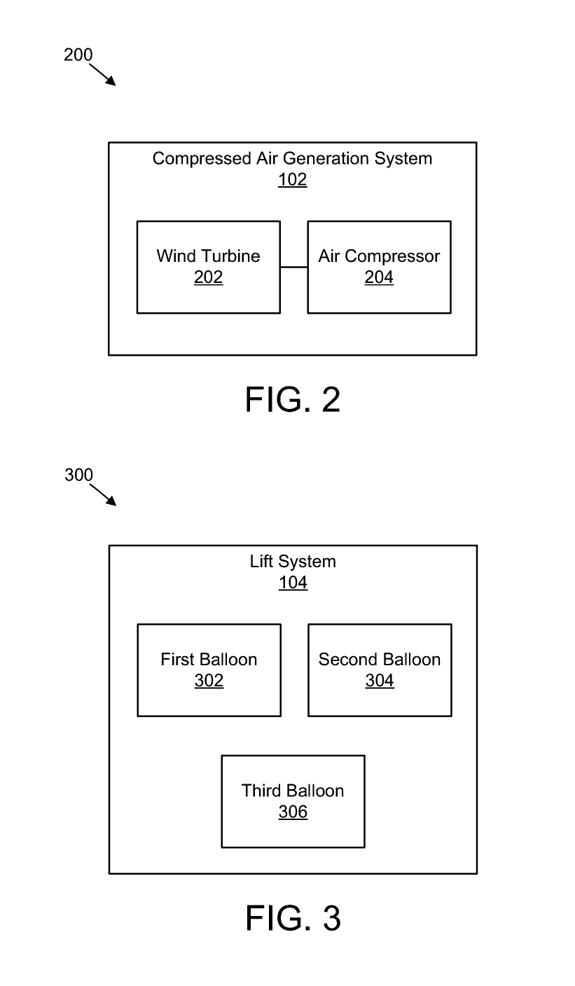

FIG. 2 is a schematic block diagram illustrating one embodiment of a compressed air generation system 200. The compressed air generation system 200 includes one embodiment of the compressed air generation system 102 as described above. Moreover, the compressed air generation system 102 includes a wind turbine 202 coupled to an air compressor 204. In response to blades of the wind turbine 202 being rotated by wind, the wind turbine 202 drives the air compressor 204 to compress air. Therefore, compressed air is generated by the compressed air generation system 102.

FIG. 3 a schematic block diagram illustrating one embodiment of a lift system 300. The lift system 300 includes one embodiment of the lift system 104 as described above. Moreover, the lift system 104 includes a first balloon 302, a second balloon 304, and a third balloon 306. The first, second, and third balloons 302, 304, and 306 may be weather balloons that have been manufactured for durability as described above, or the first, second, and third balloons 302, 304, and 306 may be any suitable type of balloon. In other embodiments, the lift system 104 may include any suitable mechanism for lifting the compressed air generation system 102 above the ground.

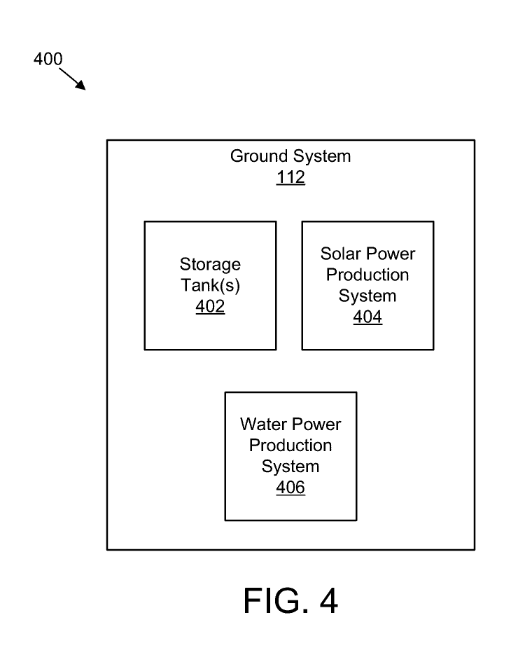

FIG. 4 a schematic block diagram illustrating one embodiment of a ground system 400. The ground system 400 includes one embodiment of the ground system 112. Moreover, the ground system 112 includes one or more storage tanks 402 that store compressed air. The ground system 112 also may include a solar power production system 404 and/or a water power production system 406. The solar power production system 404 and/or the water power production system 406 may produce compressed air that is stored in the one or more storage tanks 402 and may supplement compressed air produced by the compressed air generation system 102.

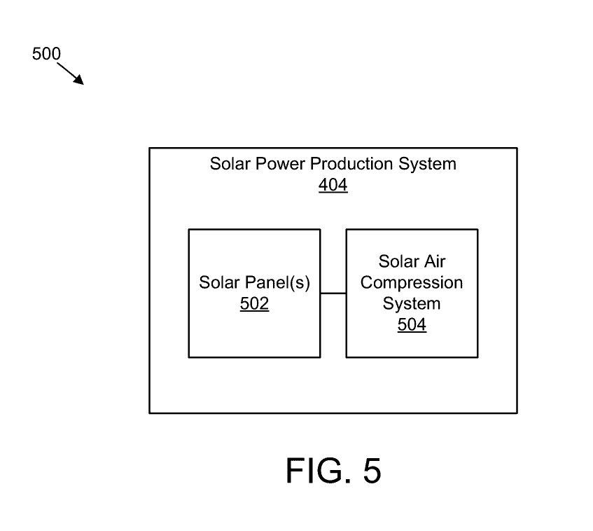

FIG. 5 a schematic block diagram illustrating one embodiment of a solar power production system 500. The solar power production system 500 includes one embodiment of the solar power production system 404. Moreover, the solar power production system 404 includes one or more solar panels 502 that produce power using solar energy. Furthermore, the solar power production system 404 includes a solar air compression system 504 that uses the power produced from the one or more solar panels 502 to produce compressed air.

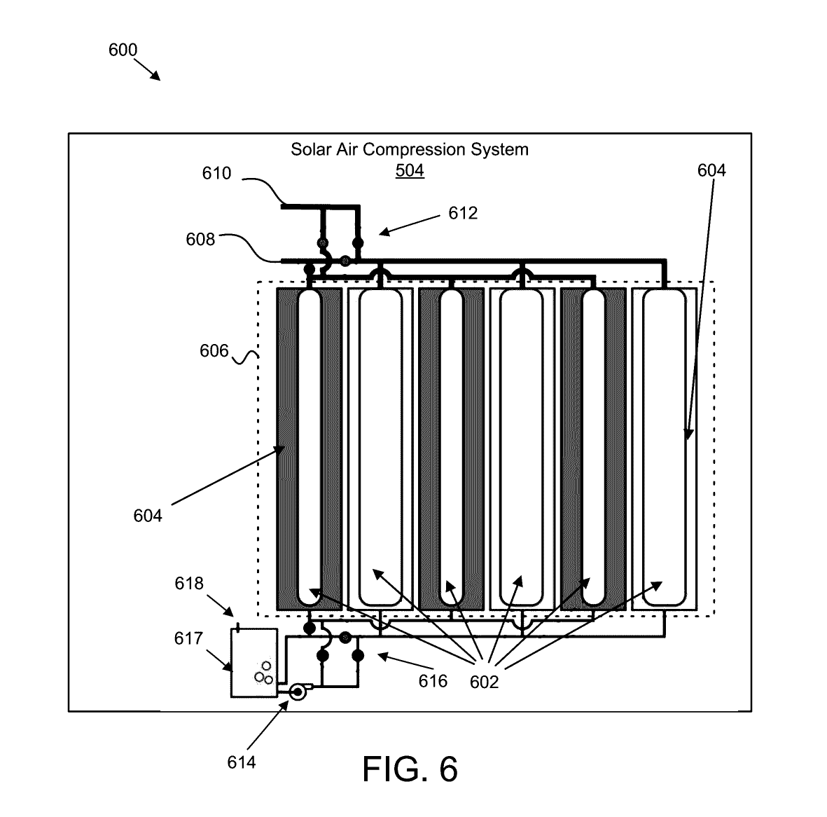

FIG. 6 a schematic block diagram illustrating one embodiment of a solar air compression system 600. The solar air compression system 600 includes one embodiment of the solar air compression system 504 that produces compressed air.

The solar air compression system 504 may use a solar photovoltaic system to directly convert sunlight into electricity. In certain embodiments, a solar photovoltaic system may have a high capital cost. For example, in one embodiment, a levelized cost of electricity produced from a solar photovoltaic system may be approximately $200 per MWhr. To reduce costs of electricity from solar power, the solar air compression system 504 may be used. The solar air compression system 504 is a solar thermal phase-change air compressor.

The solar air compression system 504 includes flexible bladders 602 disposed in respective rigid wall tubes 604. Solar thermal absorption pipes 606 may surround the flexible bladders 602 and the rigid wall tubes 604. Low pressure fluid 608 (e.g., air, gas, etc.) may be directed toward the flexible bladders 602 and high pressure fluid 610 may be directed away from the flexible bladders 602 using control valves 612.

Moreover, a pump 614 in conjunction with control valves 616 may facilitate pumping fluid from a tank 617 into the rigid wall tubes 604. Moreover, the control valves 616 may facilitate fluid flow from the rigid wall tubes 604 toward the tank 617. The tank 617 may include a vent 618 to release pressure. In some embodiments, the low pressure fluid 608 and the high pressure fluid 610 may be a first fluid, and the tank 617 may include a second fluid. In various embodiments, the first fluid may be different from the second fluid.

For example, in one embodiment, the solar air compression system 504 may use solar thermal energy to vaporize a working fluid that is injected into the rigid wall tubes 604 via the tank 617 using the pump 614. The flexible bladders 602 may be filled with air at atmospheric pressure. Heat may convert the working fluid to a high pressure gas, which compresses the flexible bladders 602 thereby compressing the air in the flexible bladders 602. Once the compressed air is released into a storage tank, the working fluid vapor is released and condensed back into a liquid, allowing air at atmospheric pressure to refill the flexible bladders 602. This process may be used and repeated to compress large volumes of air. In certain embodiments, the solar air compression system 504 may cost approximately a tenth of the cost of another solar photovoltaic system.

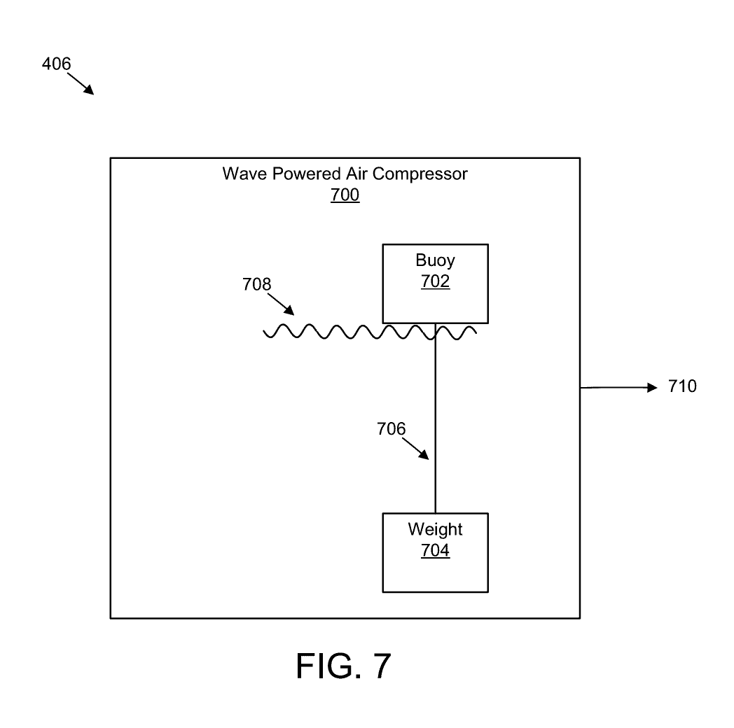

FIG. 7 a schematic block diagram illustrating one embodiment of a water power production system 406. Specifically, a wave powered air compressor 700 is illustrated. The wave powered air compressor 700 may compress air for storage. The wave powered air compressor 700 includes a buoy 702 coupled to a weight 704 sitting or attached to the bottom of the ocean. A piston 706 couples the buoy 702 on the surface and the weight 704. As waves 708 pass by the buoy 702, the buoy 702 will move up and down, compressing air on one side of the piston 706 while pulling in air on the other side of the piston 706. The wave generated compressed air 710 may be transferred to storage tanks on shore using low cost plastic tubing.

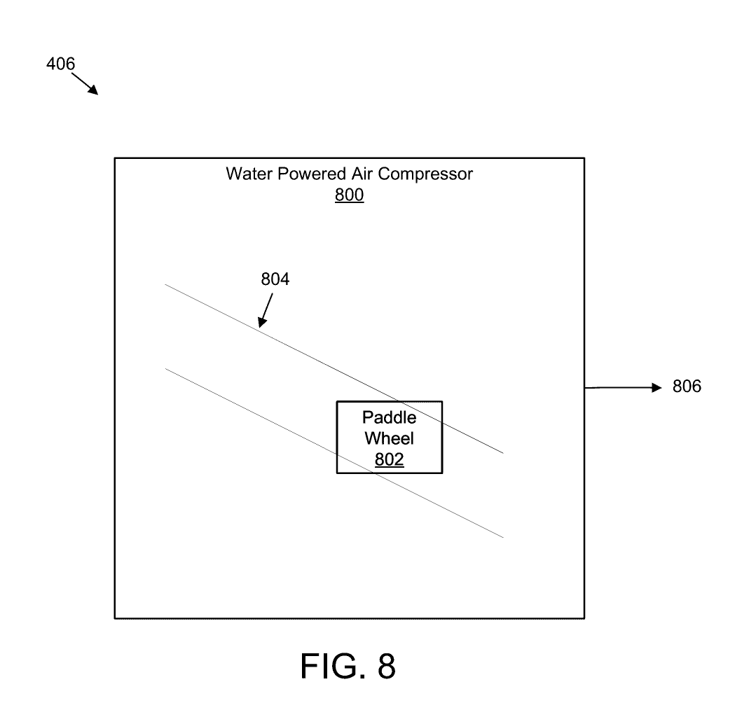

FIG. 8 a schematic block diagram illustrating one embodiment of another water power production system 406. Specifically, a water powered air compressor 800 is illustrated. The water powered air compressor 800 may compress air for storage. The water powered air compressor 800 includes a paddle wheel 802 that rotates to compress air as water flows through a river 804, thereby outputting water generated compressed air 806.

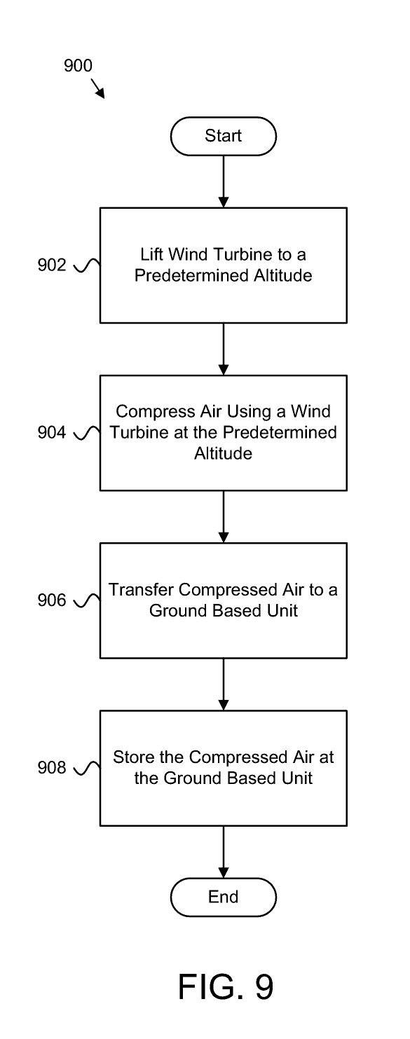

FIG. 9 is a schematic flow chart diagram illustrating an embodiment of a method 900 for power generation using compressed air. The method 900 includes lifting 902 a wind turbine to a predetermined altitude (e.g., approximately 1,000 feet). The method 900 also includes compressing 904 air using a wind turbine at the predetermined altitude. The method 900 includes transferring 906 compressed air to a ground based unit. The method 900 also includes storing 908 the compressed air at the ground based unit.

In some embodiments, there is a method or device for converting wind energy into compressed air. In various embodiments, there is a method or device in which the compressed air is stored in pressurized tanks or bags. In certain embodiments, there is a method or device in which the compressed air is used to produce electricity using an air motor driven electrical generator. In one embodiment, there is a method or device to lift a wind powered air compressor to at least 1,000 feet above the ground. In some embodiments, there is a method or device in which one or more large diameter weather balloons provide a lift. In various embodiments, there is a method for strengthening a large diameter weather balloon. In certain embodiments, there is a method or device for converting solar thermal energy into compressed air using repeated phase-changes of a working fluid. In one embodiment, there is a method or device in which compressed air is stored in pressurized tanks or bags. In some embodiments, there is a method or device in which compressed air is used to produce electricity using an air motor driven electrical generator. In various embodiments, there is a method or device for converting wave energy into compressed air. In certain embodiments, there is a method or device in which compressed air is stored in pressurized tanks or bags. In some embodiments, there is a method or device in which compressed air is used to produce electricity using an air motor driven electrical generator.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a wind turbine;
an air compressor coupled to the wind turbine, wherein the air compressor compresses air in response to rotation of blades of the wind turbine;
a balloon that lifts the wind turbine and the air compressor off the ground; and
a tube that directs the air compressed by the air compressor from the balloon to a receiving unit on the ground.
